(19) United States
(12) Patent Application Publication
(10) Pub. No.: US 2005/0209879 A1
(43) Pub. Date: Sep. 22, 2005

(54) Method and system for centralized medication fulfillment

(76) Inventor: Anne-Marie Chalmers, Osprey, FL (US)

Correspondence Address: LAHIVE & COCKFIELD, LLP., 28 STATE STREET, BOSTON, MA, 02109, US

(21) Appl. No.: 10/804,932

(22) Filed: Mar. 19, 2004

(51) Int. Cl. G06F 17/60

(52) U.S. Cl. 705/2

(57) ABSTRACT

A method and system for providing multiple medication products to a patient (for simultaneous ingestion or insertion into a live body by the patient) through a centralized medication product fulfillment facility, on an individualized, patient specific custom basis, in a cost effective, expedient manner which results in the maximization of medication intake compliance by the patient. The invention encompasses a method and system for a treating physician or physicians to electronically transmit to a centralized medication product fulfillment facility prescriptions for multiple medication products for an individual patient, with each such prescription being received electronically at the centralized medication product fulfillment facility, and with the central medication product fulfillment facility then assembling and immediately distributing, generally directly as directed by the patient, the combination dosages of multiple medication products, which can be sourced from various points of origination, with each such combination dosage of said medication products, which has been customized on a patient-by-patient basis.

### CROSS-REFERENCE TO RELATED APPLICATIONS

The sole Inventor of the invention which is the subject of this application is also the sole Inventor of the following presently pending applications: Ser. No. 10/657521 entitled Medication Delivery Device, filed with the United States Patent and Trademark Office on Sep. 8, 2003; and Ser. No. 10/690387, filed with the United States Patent and Trademark Office on Oct. 21, 2003; and Ser. No. 10/785903, filed with the United States Patent and Trademark Office on Feb. 24, 2004; and Ser. No. 10/787278, filed with the United States Patent and Trademark Office on Feb. 26, 2004.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF INVENTION

This invention relates to a method and system for providing multiple medication products to a patient (including particularly for simultaneous ingestion or insertion into a live body by the patient) through a centralized medication product fulfillment facility, on an individualized, patient specific custom basis, in a cost effective, expedient manner which results in the maximization of medication intake compliance by the patient, with such simultaneous multiple medication approach being known as “synergy medication system”.

As used herein, the phrase “centralized medication product fulfillment facility” is sometimes referred to as “CPMFC”.

As used herein, the phrase “medication product” means, includes and encompasses, but is not limited to, prescription drugs, non-prescription drugs, over-the-counter drugs, and nutritional supplements.

As used herein, “order for medication product” means, includes and encompasses physician issued prescriptions and also patient initiated requests to purchase medication products which do not require physician issued prescriptions.

In the distant past, prescriptions issued by physicians were filled by pharmacists who actually compounded the prescription from raw materials at the pharmacy, using classic tools of mortar and pestle.

In more modern times, pharmacists most often instead “repackage” pills from large bottles and place small amounts of them in small bottles, affix a label and instructions, (or in certain instances, only re-sell pre-packaged medications without any direct contact with the unpackaged medications), and sell them to patients at substantially increased prices. In effect, to some extent the role of the pharmacist has evolved to become relatively clerical and non-discretionary.

During this same period of time, the cost the patient is charged for prescription medications has generally risen appreciably. This greater cost, coupled with the fact that many people are now living much longer than in the past, and need more medications, and often live on very limited resources, exacerbates the problem of high medications expenditures.

In addition, many patients, particularly older patients, are taking a wide variety of prescription medications. This is a result of both a higher quality of available heath care available and more precise diagnostic tools.

The wide variety of medications taken currently by a typical patient creates for the patient the worrisome ask of tracking and monitoring their intake of various medications. This can be burdensome for some, and as a result many patients often do not take the correct medications on the correct schedule or in the correct amounts.

An objective of the present invention is to solve and remedy the problems described above.

One solution is to reduce cost by either eliminating the intermediary between the prescribing physician and the patient or by maximizing the efficiency of that said intermediary, thus enabling the said intermediary to share that resultant cost reduction with the patient.

An alternate solution is by decreasing the product cost by negotiating better, high volume arrangements with the source of the medication product.

As devices providing for the simultaneous delivery into a live body of multiple medication products, such as Multi-One™, become increasingly accepted in the marketplace, there will develop an increased competition among the pharmaceutical manufacturers to be participating providers of drugs, thus offering lower prices.

Also, since the devices providing for the simultaneous delivery into a live body of multiple medication products, such as Multi-One™, will deliver attractive patient-friendly delivery systems, the focus will shift from single drugs to synergistic drug combinations and thereby increasing the therapeutic effects and long term health care cost efficient.

Examples of synergy medication combinations that could benefit from simultaneous delivery into a live body include (in addition to any individualized combination prescribed by the treating physician):
(1) heart disease prevention: Omega 3+statin+aspirin+Vitamin B complex;
(2) diabetes treatment: Oral EX+Omega 3+Anti-oxidants+statin+aspirin+Vitamin B Complex;
(3) arthritis treatment: NSAIDS+Omega 3;
(4) depression/anxiety: all neuroleptica+Omega 3+Vitamin B complex;
(5) hrt: estrogens+Omega 3+Vitamin B complex+Calcium/Vitamin D;
(6) contraception: hormone+Omega 3+Vitamin B complex;
(7) Parkinson disease: Dopamine+Omega 3+Vitamin B complex;
(8) Epilepsy: RS drugs+Omega 3+Vitamin B complex;
(9) General health: Multi-Vitamins+Omega 3.

The present invention also provides for a way for the intermediary between the prescribing physician and the patient to maximize that intermediary's efficiency by optimizing communications with the prescribing physician, and streamlining assembly and packaging of multiple medication products, including those sourced from multiple pharmaceutical manufacturers, thereby reducing operating costs and increasing medication taking compliance by the patient.

The centralized medication product fulfillment facility encompassed by this invention is a vehicle and mechanism which provides for the prompt delivery to a patient of multiple medication products in a form and through a manner resulting in maximized medication intake compliance by the patient and minimized cost to the patient.

### BRIEF SUMMARY OF THE INVENTION

This invention relates to a method and system for providing multiple medication products to a patient (including particularly for simultaneous ingestion or insertion into a live body by the patient) through a centralized medication product fulfillment facility, on an individualized, patient specific custom basis, in a cost effective, expedient manner which results in the maximization of medication intake compliance by the patient.

Although the majority of said multiple medication products are drugs obtained through prescriptions issued by a physician, either in joint dosage with other prescription drugs or with non-prescription drugs, the invention also encompasses multiple medication products in situations in which none of the medication products are obtained through prescriptions from physicians but are patient orders for medication products which do not require prescriptions.

One embodiment of this invention is for a treating physician or physicians to electronically transmit to a CPMFC one or more prescriptions for an individual patient, with each such prescription being received electronically at the CPMFC from the prescribing physician, and with the CPMFC then assembling and immediately distributing either directly to patients, or in certain circumstances, to prescription “pick-up” facilities (such as retail pharmacies) located in proximity to the patient, by overnight messenger delivery service in certain circumstances (such as Federal Express or UPS), or otherwise, of combination dosages of multiple medication products, which can be sourced from various points of origination and from various medication product manufacturers, with each such combination dosage of said medication products, which has been customized on a patient-by-patient basis, being contained within fewer containers than the number of prescribed medication products, which container(s) may be biodegradable when ingested, inserted or otherwise introduced into a live body.

### BRIEF DESCRIPTION OF THE DRAWINGS

FIG. 1 is a flow chart of one embodiment of the invention.

FIG. 2 is a flow chart of a second embodiment of the invention.

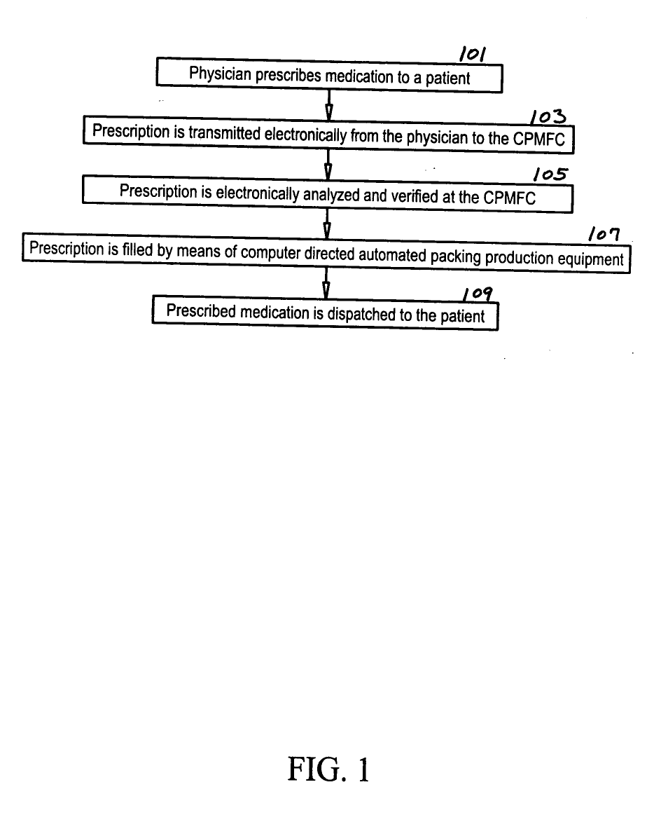

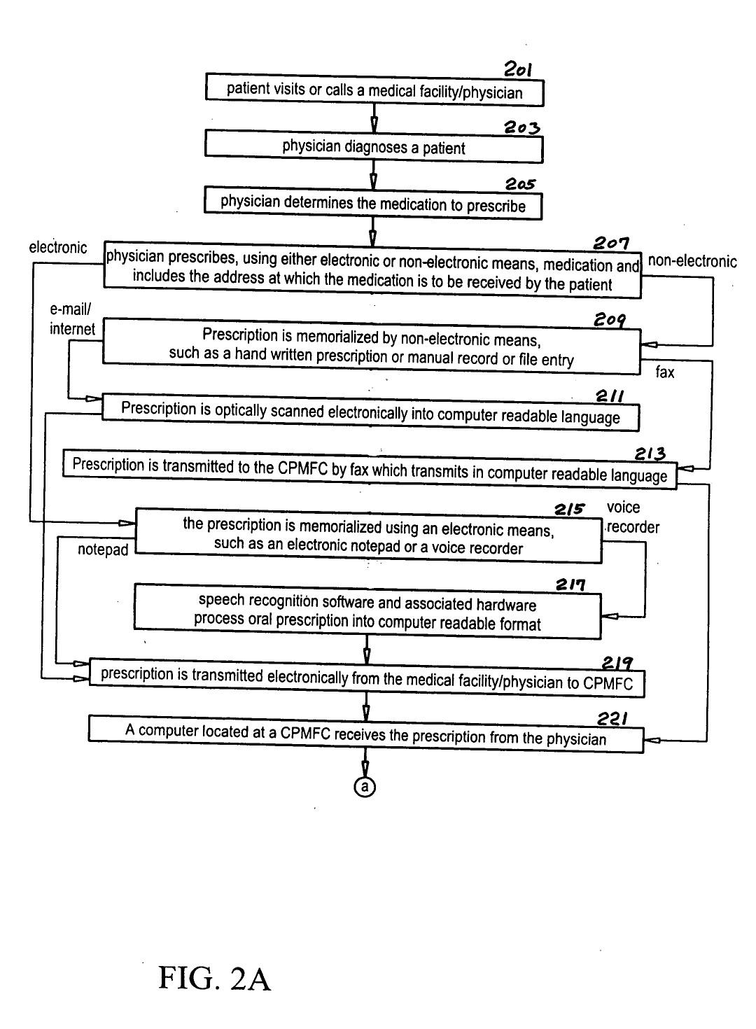

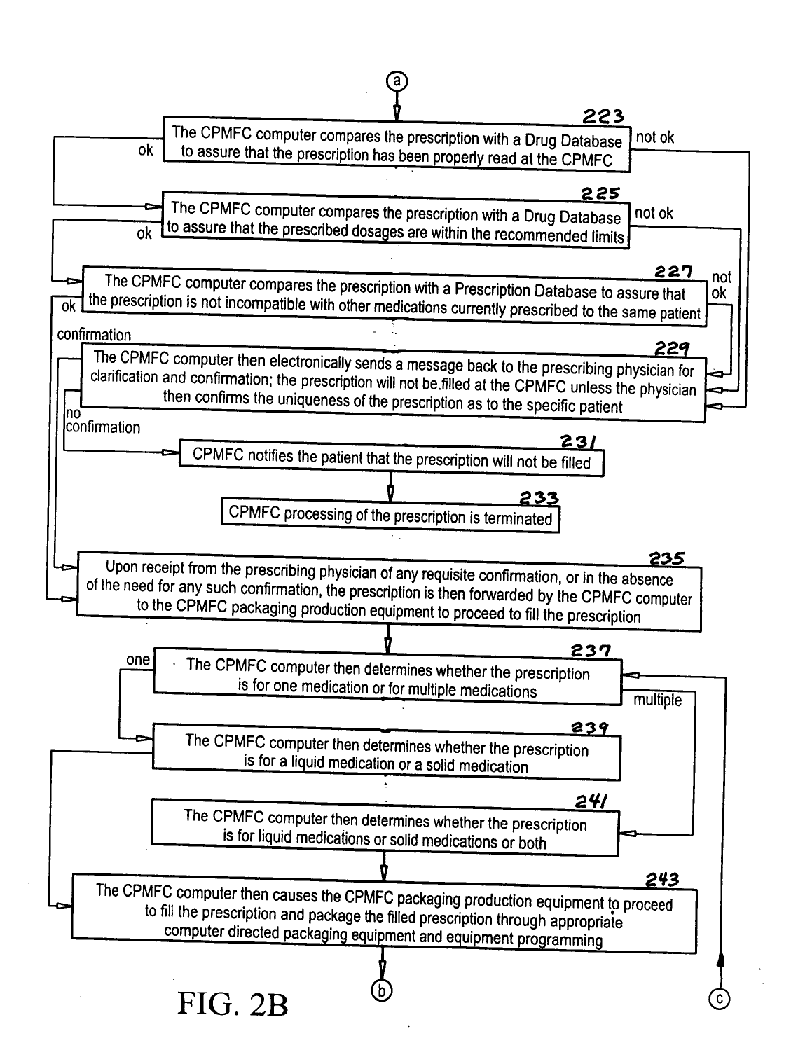

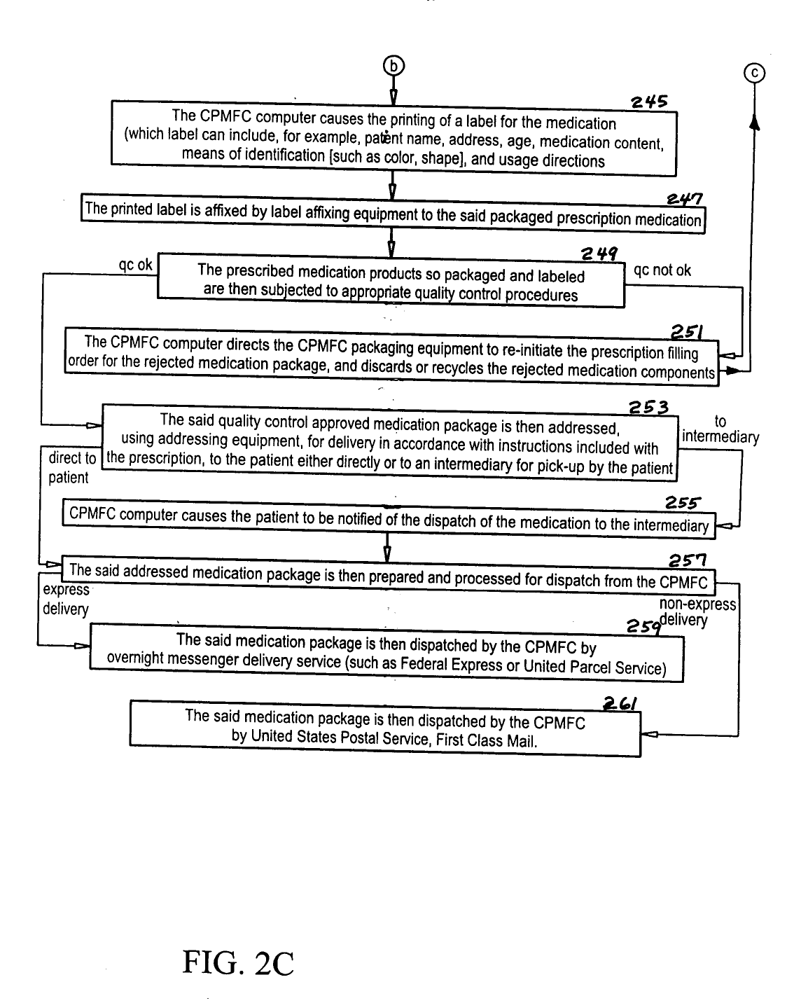

These FIG. 1 and FIG. 2 are not necessarily exhaustive of all embodiments of the invention.

### DETAILED DESCRIPTION OF THE INVENTION

Embodiments of this invention of method and system of causing a physician sourced prescription of medication for an individual patient to be received at a centralized prescription medication fulfillment center, and for that prescription to be analyzed, verified, and filled for that individual patient in an automated production line type process, and for the individual patient prescription to then be virtually immediately dispatched, directly to the individual patient or to such other location as specified by the individual patient are essentially depicted and graphically portrayed in FIG. 1 and FIG. 2.

One embodiment of the invention is depicted in FIG. 1. After a patient visits a physician, or telephones a physician, and the physician forms a conclusion regarding the preferred treatment of that ailment of the patient, the physician prescribes medication or several medications to treat the ailment of the patient (101).

It need be noted that alternatives to the patient visiting or telephoning a physician encompass other communication mechanisms, including but not limited to internet or satellite or video conferencing.

That said medication prescription is then transmitted electronically directly by the treating physician (or support staff at his office, medical group or hospital where he practices) to a centralized medication product fulfillment facility (103) for the purpose of that medication prescription being filled for the patient. When received at the centralized medication product fulfillment facility, the prescription is electronically analyzed and verified, typically by a computer, at the centralized medication product fulfillment facility (105) in an effort to assure that the medication and the dosage and drug combination are proper and appropriate. After the appropriateness of the prescription is so confirmed at the centralized medication product fulfillment facility, the prescription is filled by computer directed automated packing production equipment (107). Promptly following the said filling of the prescription, the prescribed medication is dispatched from the centralized medication product fulfillment facility directly to the patient (109).

A second embodiment of the invention is depicted in FIG. 2.

A patient with an illness or affliction or other malady, or with the possibility of being at risk of developing an illness, affliction or malady, or with an interest in minimizing the risk developing an illness, affliction or malady, visits a physician, or telephones a physician (201).

It need be noted that alternatives to the patient visiting or telephoning a physician encompass other communication mechanisms, including but not limited to internet or satellite or video conferencing.

The physician examines the patient, or if by telephone (or other communications mechanisms, including but not limited to internet or satellite or video conferencing) interviews the patient, and forms an informed opinion and conclusion, either immediately or after appropriate diagnostic tests or consultation with other medical specialists, regarding the illness, affliction or malady (203). The said physician then determines the preferred treatment of the patient and the specific medication or medications to prescribe for use by the patient (205). Obviously, the medications so prescribed, and the dosage or dosages of such medication(s), will depend upon numerous factors, all of which are considered by the physician in prescribing the said medications on an individualized, custom basis for each patient.

The said prescription documentation (207), which can be in traditional paper format or can be in electronic format, includes the name and address of the patient, both to assure the identity of the patient and to assure that the proper patient is the recipient of the prescribed mediation and also to provide a destination to which the prescription medication is to be dispatched when the prescription ifs filled. The said prescription documentation is preferably electronic, such as entered in or though an electronic “notepad” or voice recording of the prescribing physician (215), or it can be non-electronic, such as a hand written prescription on a paper pad or a hand written file entry (209). If the said prescription is by electronic notepad (215), that prescription is then transmitted electronically from the prescribing physician (including by his support staff at his office or group practice or hospital) to the centralized medication product fulfillment facility (219). If the said prescription is by voice recording (215), that voice recording is then transmitted or otherwise delivered to a computer which has speech recognition software and the oral voice recorded prescription is then electronically converted into computer readable format (217). Alternatively, the said voice recording could be transcribed by a computer input technician listening to the recording, and key-punching the prescription into a computer. The said electronic computer readable format prescription is then transmitted electronically from the prescribing physician (including by his support staff at his office or group practice or hospital) to the centralized medication product fulfillment facility (219).

If the said prescription documentation is non-electronic (207), such as a hand written prescription or a manual record or file entry (209), it is then preferably transmitted to the centralized medication product fulfillment facility by e-mail or otherwise through the internet (209), although it can also be transmitted to the centralized medication product fulfillment facility by telephone facsimile transmission (“fax”) (209) or indeed event my overnight messenger deliver service (such as Federal Express or United Parcel Service) or even by United States Postal Service First Class Mail.

If the physician used non-electronic methods and or devices to memorialize the prescription (209), the prescription set forth within non-electronic documentation by the physician can subsequently be transmitted to the centralized medication product fulfillment facility by having it optically scanned electronically into computer readable language at the physician's office, medical group practice or hospital (211), and then transmitted electronically by e-mail or otherwise by internet to the centralized medication product fulfillment facility (219).

Alternatively if the physician used non-electronic methods and or devices to memorialize the prescription (209), the prescription set forth within non-electronic documentation by the physician can subsequently be transmitted to the centralized medication product fulfillment facility by telephone facsimile transmission (“fax”) (213), which by it's very nature converts the content of the non-electronic prescription documentation into computer readable format and language, with the said fax message being transmitted from the physician to an appropriate electronic device, such as a computer, located at the centralized medication product fulfillment facility (221).

Upon receipt of the said prescription, in electronic computer readable format, at the centralized medication product fulfillment facility, a computer at the centralized medication product fulfillment facility reads the prescription and compares the prescription with a drug database to assure that the prescription has been properly read and interpreted by the computer at the centralized medication product fulfillment facility (223).

If the centralized medication product fulfillment facility computer thus confirms that the said prescription has been has been properly read and interpreted by the computer at the centralized medication product fulfillment facility (223), the said computer then compares the prescription with a drug database to assure that the dosages are within recommended limits (225).

If the centralized medication product fulfillment facility computer thus confirms that the said prescription is within recommended limits (225), the said computer then compares the prescription with a prescription database to assure that the prescription drugs are not incompatible with each other or with other medications then currently prescribed to the same patient (227).

In this regard it is noted that the centralized medication product fulfillment facility computer can search an appropriate database for other current prescriptions for the same patient issued by several different physicians, and if it locates any such current prescriptions for the same patient, and they are from different physicians, the centralized medication product fulfillment facility can determine by referring to appropriate data bases, whether the said multiple-sourced prescriptions are compatible with each other, if taken by the same patient during the same period of time.

If the centralized medication product fulfillment facility computer thus confirms that the said prescription is not incompatible with other medications then currently prescribed to the same patient (227), then the said centralized medication product fulfillment facility computer directs the centralized medication product fulfillment facility packaging production equipment to proceed to fill the said prescription (235).

If, however, upon receipt of the said prescription, in electronic computer readable format, at the centralized medication product fulfillment facility, a computer at the centralized medication product fulfillment facility is not able to assure that the prescription had been properly read by the computer at the computer at the centralized medication product fulfillment facility (223), or is not able to confirm that the said prescription is within recommended limits (225), or is not able to confirm that the prescription is not incompatible with other medications then currently prescribed to the same patient (227), then the centralized medication product fulfillment facility computer sends a message back to the prescribing physician for clarification and confirmation (229). If the prescribing physician does not timely notify the centralized medication product fulfillment facility and confirm the uniqueness of the prescription as to the specific patient, the centralized medication product fulfillment facility computer notifies the patient that the prescription will not be filled (231) and the centralized medication product fulfillment facility processing of the prescription is terminated (233).

However, if the prescribing physician does timely notify the centralized medication product fulfillment facility and confirms the uniqueness of the prescription as to the specific patient, then the said centralized medication product fulfillment facility computer directs the centralized medication product fulfillment facility packaging production equipment to proceed to fill the said prescription (235).

Upon the centralized medication product fulfillment facility computer directing the centralized medication product fulfillment facility packaging production equipment to proceed to fill the prescription (235), the centralized medication product fulfillment facility computer then determines whether the prescription is for one medication or for multiple medications (237).

If the centralized medication product fulfillment facility computer determines that the prescription is for one medication (237), said prescription is for one medication, the centralized medication product fulfillment facility computer then determines whether the prescription is for a liquid medication or a solid medication (239). The centralized medication product fulfillment facility computer then causes the centralized medication product fulfillment facility packaging production equipment to proceed to fill the prescription and package the filled prescription medication through appropriate computer directed packaging equipment and equipment programming (243).

Alternatively, if the centralized medication product fulfillment facility computer determines that the prescription is for multiple medications (237), said prescription is for one medication, the centralized medication product fulfillment facility computer then determines whether the prescription is for liquid medications or solid medications or both (241). The centralized medication product fulfillment facility computer then causes the centralized medication product fulfillment facility packaging production equipment to proceed to fill the prescription and package the filled prescription medication through appropriate computer directed packaging equipment and equipment programming (243).

With the centralized medication product fulfillment facility packaging production equipment, having thusly (243) been directed by the centralized medication product fulfillment facility computer to fill the said prescription, the centralized medication product fulfillment facility computer then causes the printing of the appropriate label for the said prescription medication (245). The said label(s) can include, for example, patient name, address, age, medication content, identifier [such as color or shape] and usage directions (245).

The thusly printed label (245) is then affixed to the packaged prescription medication (243), as depicted at (247).

The prescribed medication so packaged and labeled are then subjected to appropriate quality control procedures (249).

If the said packaged and labeled prescribed medication is approved by the said quality control procedures (249), the said packaged and labeled prescribed medication is then addressed, using addressing equipment, for delivery in accordance with instructions included with the prescription (207) as received at the centralized medication product fulfillment facility from the prescribing physician (221), either to the patient directly of to an intermediary for pick-up by the patient (253). In this regard, although delivery directly to the patient is generally the most expedient delivery mechanism, there are situations and circumstances as to which delivery to an intermediary is preferable, such as to a retail pharmacy at which related products would also be available, or to a hospital or convalescence facility at which the patient may be confined and at which control over mediations taken by a patient is necessary.

If the said packaged, labeled and addressed medication (253) is to be sent by the centralized medication product fulfillment facility directly to the patient (253), the said addressed mediation package is then prepared and processed for dispatch from the centralized medication product fulfillment facility (257). Alternatively, if the said packaged, labeled and addressed medication (253) is to be sent by the centralized medication product fulfillment facility to an intermediary on behalf of the patient, then the centralized medication product fulfillment facility computer causes the patient to be notified of the dispatch of the medication to the intermediary (255), and the said addressed mediation package is then prepared and processed fro dispatch from the centralized medication product fulfillment facility (257).

The said packaged, labeled and addressed medication can be dispatched by the centralized medication product fulfillment facility either for express delivery or for non-express delivery (257).

If the said dispatch is to be by express delivery, the said medication package is then dispatched by the centralized medication product fulfillment facility by overnight messenger delivery service, such as Federal Express or United Parcel Service (259).

Alternatively, if the said dispatch is to be by non-express delivery, the said medication package is then dispatched by the centralized medication product fulfillment facility by United States Postal Service, First Class Mail (261).

With regard to the centralized medication product fulfillment facility packaging production equipment referred to in the second embodiment described herein, if the prescription is for a non-liquid single medication, but including liquids contained within liquid gel caps, the prescription can be filled by an automated packaging production line in which the prescribed pills, capsules or gel caps are removed from relatively large containers and are electro-mechanically deposited into a small container.

Similarly, if the prescription is for a liquid single medication, the prescription can be filled by an automated packaging production line in which the prescribed liquid medication is from relatively large containers and is electro-mechanically deposited into a small container. Furthermore, if the prescription is for multiple non-liquid medications but including liquids contained within liquid gel caps, the prescription can be filled by an automated packaging production line in which the various prescribed pills, capsules or gel caps are removed from the respective relatively large containers and are electro-mechanically deposited into several small containers.

Alternatively if the prescription is for multiple non-liquid medications but including liquids contained within liquid gel caps, the prescription can be filled by an automated packaging production line in which the various prescribed pills, capsules or gel caps are removed from the respective relatively large containers and are electro-mechanically deposited into numerous individual dosage containers (such as one-portion sized zipper closure type bags, or blister packages), with each such individual dosage container holding the several medications which the patient is to take at the same time, with the appropriate drug label affixed to each such individual drug container; the said individual dosage container may (or may not) itself be constructed of a material which is itself biodegradable when ingested or inserted into a live body.

Further alternatively, if the prescription is for multiple non-liquid medications but including liquids contained within liquid gel caps, the prescription can be filled by an automated packaging production line in which the various prescribed pills, capsules or gel caps are removed from the respective relatively large containers and are electro-mechanically deposited into numerous blister pack cards or substrates or portion thereof, with each such blister card or substrate or portion thereof to hold one individual dosage of each of the several medications which the individual patient is to take at the same time, with the appropriate drug label affixed to each such individual drug container.

Again further alternatively, if the prescription is for multiple non-liquid medications, the prescription can be filled by an automated packaging production line in which the various prescribed medications had been reformulated to be in pill form, with each such pill to be of a standardized color, size and shape (for both ready identification and to facilitate handling) for a specific medication a specific unit dosage amount, with said pills having been designed specifically to be insertable into a specific standardized capsule-type outer container, which capsule type container is itself intended to be ingested or inserted into a live body, and to be biodegradable when inside of a live body, with the appropriate drug label affixed to each bottle or other “bulk” container into which the said capsule type outer containers are automatically inserted and packaged at the central facility.

Although the embodiments described above are for multiple medication products which are drugs obtained through prescriptions issued by a physician, either in joint dosage with other prescription drugs or with non-prescription drugs, the invention also encompasses multiple medications, none of which are obtained through prescriptions from physicians but are non-prescription drugs, including nutritional supplements.

It is recognized and understood that the above described embodiments of the invention are illustrative only, and that this invention is not to be regarded as limited in any way or to any extent to the embodiments disclosed herein, but is to be limited only by the Claims set forth herein.

1. A method for the fulfillment, at a centralized medication product fulfillment facility, of orders for multiple medication products, comprising the steps of:
sending orders for multiple medication production products to a centralized medication product fulfillment facility;
filling the said orders for multiple medication products at the said centralized medication product fulfillment facility; and
sending the said medication products as directed in said order.

2. A method for the fulfillment, at a centralized medication product fulfillment facility, of prescriptions for multiple medication products, for simultaneous ingestion or insertion into a live body, comprising the steps of:
prescribing by a physician of a prescription for medication products for an individual patient;
sending the said prescription electronically to, and receiving the said prescription at, a centralized medication product fulfillment facility;
filling the said prescription at the centralized medication product fulfillment facility; and
sending the said medication product from the centralized medication product fulfillment facility directly to the patient.

3. A method for the fulfillment, at a centralized medication product fulfillment facility, of prescriptions for multiple medication products, for simultaneous ingestion or insertion into a live body, comprising the steps of:
prescribing by a physician of a prescription for medication products for an individual patient;
sending the said prescription electronically to, and receiving the said prescription at, a centralized medication product fulfillment facility;
filling the said prescription at the centralized medication product fulfillment facility; and
sending the said medication product from the centralized medication product fulfillment facility directly to an intermediary for subsequent pick-up by the patient at the location of the intermediary.

4. A method for the fulfillment, at a centralized medication product fulfillment facility, of prescriptions for multiple medication products, for simultaneous ingestion or insertion into a live body, comprising the steps of:
prescribing by a physician of a prescription for medication products for an individual patient;
sending the said prescription electronically to, and receiving the said prescription at, a centralized medication product fulfillment facility;
confirming at the centralized medication product fulfillment facility the accuracy of the said prescription;
filling the said prescription at the centralized medication product fulfillment facility; and
sending the said prescription from the centralized medication product fulfillment facility directly to the patient.

5. A method for the fulfillment, at a centralized medication product fulfillment facility, of prescriptions for multiple medication products, for simultaneous ingestion or insertion into a live body, comprising the steps of:
prescribing by a physician of a prescription for medication products for an individual patient;
sending the said prescription electronically to, and receiving the said prescription at, a centralized medication product fulfillment facility;
confirming at the centralized medication product fulfillment facility the accuracy of the said prescription;
filling the said prescription at the centralized medication product fulfillment facility; and
sending the said prescription from the centralized medication product fulfillment facility directly to an intermediary for subsequent pick-up by the patient at the location of the intermediary.

6. A method for the fulfillment, at a centralized medication product fulfillment facility, of prescriptions for multiple medication products, for simultaneous ingestion or insertion into a live body, comprising the steps of:
communicating, by communication means, between a patient and a physician regarding a health condition of the patient;
diagnosing by a physician of a health condition of a patient;
prescribing by the physician of medication to address the health condition of the patient;
sending the said prescription to a centralized medication product fulfillment facility;
filing the said prescription through a computer directed automated assembly production line at the centralized medication product fulfillment facility; and
dispatching the said medication product from the centralized medication product fulfillment facility to the patient.

7. The method of claim 6, in which the said communication means is a personal visit be the patient to the physician.

8. The method of claim 6, in which the said communications means is a telephone call between the patient and the physician.

9. The method of claim 6, in which the said communications means is a video conference between the patient and the physician.

10. The method of claim 6, in which the said communications means is a satellite communication between the patient and the physician.

11. The method of claim 6, in which the said communications means is an internet communication between the patient and the physician.

12. A system for the fulfillment, at a centralized medication product fulfillment facility, of prescriptions for multiple medication products, for simultaneous ingestion or insertion into a live body, comprising
means for a prescribing physician to transmit a prescription for medication for an individual patient to be immediately electronically sent to and received at a centralized medication product fulfillment facility;
means at the centralized medication product fulfillment facility to confirm the accuracy of the said prescription;
means for the centralized medication product fulfillment facility to fill the said prescription; and
means for the centralized medication product fulfillment facility to send the prescription medication directly to the patient.

13. A system for the fulfillment, at a centralized medication product fulfillment facility, of prescriptions for multiple medication products, for simultaneous ingestion or insertion into a live body, comprising
means for a prescribing physician to transmit a prescription for medication for an individual patient to be immediately electronically sent to and received at a centralized medication product fulfillment facility;
means at the centralized medication product fulfillment facility to confirm the accuracy of the said prescription;
means for the centralized medication product fulfillment facility to fill the said prescription; and
means for the centralized medication product fulfillment facility to send the prescription medication directly to an intermediary for subsequent pick-up by the patient at the location of the intermediary.

14. A method for the fulfillment, at a centralized medication product fulfillment facility, of prescriptions for multiple medication products, for simultaneous ingestion or insertion into a live body, comprising the steps of:
prescribing by a physician of a prescription for medication for an individual patient;
sending the said prescription electronically to, and receiving the said prescription at, a centralized medication fulfillment center;
confirming at the centralized medication product fulfillment facility the accuracy of the said prescription;
confirming at the centralized medication product fulfillment facility the safe dosage of the said prescription;
confirming at the centralized medication product fulfillment facility the safe drug combination of the said prescription;
filling the said prescription in individualized, customized presentation packaging; and
sending the said prescription from the centralized medication product fulfillment facility directly to the patient.

15. A method for the fulfillment, at a centralized medication product fulfillment facility, of prescriptions for multiple medication products, for simultaneous ingestion or insertion into a live body, comprising the steps of:
prescribing by a physician of a prescription for medication for an individual patient;
sending the said prescription electronically to, and receiving the said prescription at, a centralized medication fulfillment center;
confirming at the centralized medication product fulfillment facility the accuracy of the said prescription;
confirming at the centralized medication product fulfillment facility the safe dosage of the said prescription;
confirming at the centralized medication product fulfillment facility the safe drug combination of the said prescription;
filling the said prescription in individualized, customized presentation packaging; and
sending the said prescription from the centralized medication product fulfillment facility directly to an intermediary for subsequent pick-up by the patient at the location of the intermediary.

16. A system for the fulfillment, at a centralized medication product fulfillment facility, of prescriptions for multiple medication products, for simultaneous ingestion or insertion into a live body, comprising:
means for a prescribing physician to transmit a prescription for medication for an individual patient to be immediately electronically sent to and received at a centralized medication product fulfillment facility;
means at the centralized medication product fulfillment facility to confirm the accuracy of the said prescription;
means at the centralized medication product fulfillment facility to confirm the safe dosage of the said prescription;
means at the centralized medication product fulfillment facility to confirm the safe drug combination of the said prescription;
means for the centralized medication product fulfillment facility to fill the said prescription in an individualized, customized presentation packaging; and
means for the centralized medication product fulfillment facility to send the prescription medication directly to the patient.

17. A system for the fulfillment, at a centralized medication product fulfillment facility, of prescriptions for multiple medication products, for simultaneous ingestion or insertion into a live body, comprising
means for a prescribing physician to transmit a prescription for medication for an individual patient to be immediately electronically sent to and received at a centralized medication product fulfillment facility;
means at the centralized medication product fulfillment facility to confirm the accuracy of the said prescription;
means at the centralized medication product fulfillment facility to confirm the safe dosage of the said prescription;
means at the centralized medication product fulfillment facility to confirm the safe drug combination of the said prescription;
means for the centralized medication product fulfillment facility to fill the said prescription in an individualized, customized presentation packaging; and
means for the centralized medication product fulfillment facility to send the prescription medication directly to an intermediary for subsequent pick-up by the patient at the location of the intermediary.

18. A method for the fulfillment, at a centralized medication product fulfillment facility, of prescriptions for multiple medication products, for simultaneous ingestion or insertion into a live body, comprising the steps of:
visiting a medical facility/physician by a patient;
diagnosing by a physician of the health condition of a patient;
determining by a physician the medication to prescribe for the patient;
prescribing by a physician of medication for a patient;
recording and memorializing the said prescription by the physician using electronic means an electronic notepad;
transmitting the said prescription electronically to, and receiving the said prescription at, a centralized prescription medication fulfillment facility;
receiving at a computer located at a centralized the prescription medication fulfillment facility the prescription from the physician;
comparing by the centralized prescription medication fulfillment facility computer the said prescription with a drug database to assure that the prescription has been properly read at the centralized prescription medication fulfillment facility;
comparing by the centralized prescription medication fulfillment facility computer the prescription with a drug database to assure that the prescribed dosages are within the recommended limits;
comparing by the centralized prescription medication fulfillment facility computer the prescription with a prescription database to assure that the prescription is not incompatible with other medications currently prescribed to the same patient;
transmitting electronically by the centralized prescription medication fulfillment facility computer a message back to the prescribing physician for clarification and confirmation if the said prescription is not understood by the centralized prescription medication fulfillment facility computer, or if the said prescription is for dosages which are not within recommended limits, or if the said prescription is not compatible with other medications then currently taken by the same patient; notifying the patient by the centralized prescription medication fulfillment facility computer that the prescription will not be filled at the centralized prescription medication fulfillment facility, if the centralized prescription medication fulfillment facility had not received any requisite confirmation from the physician confirming the uniqueness of the prescription as to the specific patient;
determining by the centralized prescription medication fulfillment facility computer whether the prescription is for one medication or for multiple medications;
determining by the centralized prescription medication fulfillment facility computer whether the prescription is for liquid medication or for solid medication or for both;
directing by the centralized prescription medication fulfillment facility computer to the centralized prescription medication fulfillment facility packing production equipment to fill the prescription;
causing by the centralized prescription medication fulfillment facility computer the printing of a label for the medication;
affixing the said printed label by centralized prescription medication fulfillment facility label affixing equipment to the said packaged prescription medication;
subjecting the said packaged and labeled prescribed medications to appropriate quality control procedures;
addressing the said quality control approved medication package, using centralized prescription medication fulfillment facility computer directed addressing equipment, for delivery in accordance with instructions provided by or for the patient;
preparing and processing the said addressed medication package for dispatch from the centralized prescription medication fulfillment facility; and
dispatching the said medication package by overnight messenger delivery service directly to the patient.

19. The method of claim 18, in which the said electronic recording and memorializing means is an electronic notepad.

20. A method for the fulfillment, at a centralized medication product fulfillment facility, of prescriptions for multiple medication products, for simultaneous ingestion or insertion into a live body, comprising the steps of:
visiting a medical facility/physician by a patient;
diagnosing by a physician of the health condition of a patient;
determining by a physician the medication to prescribe for the patient;
prescribing by a physician of medication for a patient;
recording and memorializing the said prescription by the physician orally using a voice recorder;
processing and converting the said orally recorded prescription, using speech recognition software and associated hardware, into computer readable format and language;
transmitting the said prescription electronically to, and receiving the said prescription at, a centralized prescription medication fulfillment facility;
receiving at a computer located at a centralized the prescription medication fulfillment facility the prescription from the physician;
comparing by the centralized prescription medication fulfillment facility computer the said prescription with a drug database to assure that the prescription has been properly read at the centralized prescription medication fulfillment facility;
comparing by the centralized prescription medication fulfillment facility computer the prescription with a drug database to assure that the prescribed dosages are within the recommended limits;
comparing by the centralized prescription medication fulfillment facility computer the prescription with a prescription database to assure that the prescription is not incompatible with other medications currently prescribed to the same patient;
transmitting electronically by the centralized prescription medication fulfillment facility computer a message back to the prescribing physician for clarification and confirmation if the said prescription is not understood by the centralized prescription medication fulfillment facility computer, or if the said prescription is for dosages which are not within recommended limits, or if the said prescription is not compatible with other medications then currently taken by the same patient;
notifying the patient by the centralized prescription medication fulfillment facility computer that the prescription will not be filled at the centralized prescription medication fulfillment facility, if the centralized prescription medication fulfillment facility had not received any requisite confirmation from the physician confirming the uniqueness of the prescription as to the specific patient;
determining by the centralized prescription medication fulfillment facility computer whether the prescription is for one medication or for multiple medications;
determining by the centralized prescription medication fulfillment facility computer whether the prescription is for liquid medication or for solid medication or for both;
directing by the centralized prescription medication fulfillment facility computer to the centralized prescription medication fulfillment facility packing production equipment to fill the prescription;
causing by the centralized prescription medication fulfillment facility computer the printing of a label for the medication;
affixing the said printed label by centralized prescription medication fulfillment facility label affixing equipment to the said packaged prescription medication;
subjecting the said packaged and labeled prescribed medications to appropriate quality control procedures;
addressing the said quality control approved medication package, using centralized prescription medication fulfillment facility computer directed addressing equipment, for delivery in accordance with instructions provided by or for the patient;
preparing and processing the said addressed medication package for dispatch from the centralized prescription medication fulfillment facility; and
dispatching the said medication package by overnight messenger delivery service directly to the patient.

21. A method for the fulfillment, at a centralized medication product fulfillment facility, of prescriptions for multiple medication products, for simultaneous ingestion or insertion into a live body, comprising the steps of:
visiting a medical facility/physician by a patient;
diagnosing by a physician of the health condition of a patient;
determining by a physician the medication to prescribe for the patient;
prescribing by a physician of medication for a patient;
recording and memorializing the said prescription by the physician using a non-electronic means;
scanning, using optical scanning software and associated hardware, the said hand written prescription, and converting it into computer readable format and language;
transmitting the said prescription electronically to, and receiving the said prescription at, a centralized prescription medication fulfillment facility;
receiving at a computer located at a centralized the prescription medication fulfillment facility the prescription from the physician;
comparing by the centralized prescription medication fulfillment facility computer the said prescription with a drug database to assure that the prescription has been properly read at the centralized prescription medication fulfillment facility;
comparing by the centralized prescription medication fulfillment facility computer the prescription with a drug database to assure that the prescribed dosages are within the recommended limits;
comparing by the centralized prescription medication fulfillment facility computer the prescription with a prescription database to assure that the prescription is not incompatible with other medications currently prescribed to the same patient;
transmitting electronically by the centralized prescription medication fulfillment facility computer a message back to the prescribing physician for clarification and confirmation if the said prescription is not understood by the centralized prescription medication fulfillment facility computer, or if the said prescription is for dosages which are not within recommended limits, or if the said prescription is not compatible with other medications then currently taken by the same patient;
notifying the patient by the centralized prescription medication fulfillment facility computer that the prescription will not be filled at the centralized prescription medication fulfillment facility, if the centralized prescription medication fulfillment facility had not received any requisite confirmation from the physician confirming the uniqueness of the prescription as to the specific patient;
determining by the centralized prescription medication fulfillment facility computer whether the prescription is for one medication or for multiple medications;
determining by the centralized prescription medication fulfillment facility computer whether the prescription is for liquid medication or for solid medication or for both;
directing by the centralized prescription medication fulfillment facility computer to the centralized prescription medication fulfillment facility packing production equipment to fill the prescription;
causing by the centralized prescription medication fulfillment facility computer the printing of a label for the medication;
affixing the said printed label by centralized prescription medication fulfillment facility label affixing equipment to the said packaged prescription medication;
subjecting the said packaged and labeled prescribed medications to appropriate quality control procedures;
addressing the said quality control approved medication package, using centralized prescription medication fulfillment facility computer directed addressing equipment, for delivery in accordance with instructions provided by or for the patient;
preparing and processing the said addressed medication package for dispatch from the centralized prescription medication fulfillment facility; and
dispatching the said medication package by overnight messenger delivery service directly to the patient.

22. The method of claim 21, in which the said non-electronic recording and memorializing means is a handwritten prescription pad sheet of paper.

23. The method of claim 21, in which the said non-electronic recording and memorializing means is an entry on a paper file record at the physician's office.

24. A method for the fulfillment, at a centralized medication product fulfillment facility, of prescriptions for multiple medication products, for simultaneous ingestion or insertion into a live body, comprising the steps of:
visiting a medical facility/physician by a patient;
diagnosing by a physician of the health condition of a patient;
determining by a physician the medication to prescribe for the patient;
prescribing by a physician of medication for a patient;
recording and memorializing the said prescription by the physician using a non-electronic means;
transmitting the said non-electronic recorded and memorialized prescription, using telephone facsimile transmission software and associated hardware, to, and receiving the said prescription at, a centralized prescription medication fulfillment facility;
receiving at a computer located at a centralized the prescription medication fulfillment facility the prescription from the physician;
comparing by the centralized prescription medication fulfillment facility computer the said prescription with a drug database to assure that the prescription has been properly read at the centralized prescription medication fulfillment facility;
comparing by the centralized prescription medication fulfillment facility computer the prescription with a drug database to assure that the prescribed dosages are within the recommended limits;
comparing by the centralized prescription medication fulfillment facility computer the prescription with a prescription database to assure that the prescription is not incompatible with other medications currently prescribed to the same patient;
transmitting electronically by the centralized prescription medication fulfillment facility computer a message back to the prescribing physician for clarification and confirmation if the said prescription is not understood by the centralized prescription medication fulfillment facility computer, or if the said prescription is for dosages which are not within recommended limits, or if the said prescription is not compatible with other medications then currently taken by the same patient;
notifying the patient by the centralized prescription medication fulfillment facility computer that the prescription will not be filled at the centralized prescription medication fulfillment facility, if the centralized prescription medication fulfillment facility had not received any requisite confirmation from the physician confirming the uniqueness of the prescription as to the specific patient;
determining by the centralized prescription medication fulfillment facility computer whether the prescription is for one medication or for multiple medications;
determining by the centralized prescription medication fulfillment facility computer whether the prescription is for liquid medication or for solid medication or for both;
directing by the centralized prescription medication fulfillment facility computer to the centralized prescription medication fulfillment facility packing production equipment to fill the prescription;
causing by the centralized prescription medication fulfillment facility computer the printing of a label for the medication;
affixing the said printed label by centralized prescription medication fulfillment facility label affixing equipment to the said packaged prescription medication;
subjecting the said packaged and labeled prescribed medications to appropriate quality control procedures;
addressing the said quality control approved medication package, using centralized prescription medication fulfillment facility computer directed addressing equipment, for delivery in accordance with instructions provided by or for the patient;
preparing and processing the said addressed medication package for dispatch from the centralized prescription medication fulfillment facility; and
dispatching the said medication package by overnight messenger delivery service directly to the patient.
